(19) United States
(12) Patent Application Publication
(10) Pub. No.: US 2021/0394848 A1
(43) Pub. Date: Dec. 23, 2021

(54) CHARGING STAND FOR ELECTRIC MOTORCYCLES

(71) Applicant: TWIG Power, LLC, Novi, MI (US)

(72) Inventor: Jesse Beeker, Novi, MI (US)

(21) Appl. No.: 17/353,651

(22) Filed: Jun. 21, 2021

Related U.S. Application Data
(60) Provisional application No. 63/041,512, filed on Jun. 19, 2020.

(51) Int. Cl. B62H 3/00; B60L 55/00; B60L 53/302; B60L 53/30; B60L 53/53

(52) U.S. Cl. CPC B62H 3/00; B60L 55/00; B60L 53/302; B60L 53/305; B62H 2700/00; B60L 2200/12; B60L 2210/10; B60L 2210/40; B60L 53/53

(57) ABSTRACT

Disclosed herein is a novel electric motorcycle charging stand and methods of using such a novel electric motorcycle charging stand for charging an electric motorcycle. Such stands present an opportunity to include functionality for storing energy and incorporate electronical components in the stand to charge electric motorcycles when not in use. In one embodiment a detached motorcycle stand can be arranged to stores electrical energy (for example, via an electrical energy storage element) and enables charging of an electric motorcycle (for example, via a charging enablement element). Thus, energy can be stored when there is convenient access to the electrical power grid and the electric motorcycle can then be charged in environments and locations that do not have ready access to the electrical grid.

### CROSS-REFERENCE TO RELATED APPLICATIONS

This application claims priority to U.S. Provisional Patent Application No. 63/041,512 titled “Charging Stand for Electrical Motorcycles” and filed on Jun. 19, 2020, the disclosure of this patent application being incorporated herein by reference in their entirety.

### FIELD OF INVENTION

The present disclosure generally relates to a system for recharging a battery of an electric motorcycle. More specifically, the present disclosure relates to a motorcycle stand that includes the structure and functionality to recharge the battery of an electric motorcycle when the motorcycle is not in use.

### BACKGROUND

Electric motorcycles are being adopted by manufacturers and consumers globally, with the market share of electric motorcycles consistently growing year over year. The United States and European markets offer a large variety of motorcycles with electric powertrains, with many marketed for traditional transportation purposes, but an increasing number marketed and used for non-traditional purposes, such as off-road recreational purposes. While larger electronic motorcycles have integrated onboard charging equipment and functionality to facilitate plugging the motorcycle directly into a standard electrical outlet for recharging, certain other motorcycles used for various applications do not provide for charger functionality to be integrated directly in the motorcycle. For example, smaller motorcycles typically are not built with direct charging functionality and require separate equipment to recharge the batter of such motorcycles.

A large part of the motorcycle market is recreational, with smaller and lighter motorcycles dominating such recreational use. Recreational motorcycles are often used in areas where there is little or no direct access to electricity. This is problematic for electric motorcycles, especially for electric motorcycles used in off-road and racing environments. In such environments, it is typical and often legally required to transport the motorcycle to the riding location by riding the motorcycle. Furthermore, these locations are typically without any access to the electrical power grid. Thus, rider often resort to bringing an internal combustion engine electricity generator (“ICE generator”) to the location in order for the rider to have access to electricity to recharge the electric motorcycle.

In many cases, the use of an ICE generator is contrary to the benefits of using an electric motorcycle, particularly using an ICE generator in remote locations. Portable ICE generators are subject to relaxed emissions standards and create significantly more pollution than an automobile or even gasoline motorcycle. ICE generators also produce significant noise. Thus, using an ICE generator creates a situation where charging the battery of a clean and quiet electric motorcycle is accomplished by a loud and environmentally damaging ICE generator. Alternative energy solution to charging a electric motorcycle are not robust enough to provide a meaningful amount of energy for the motorcycle in a remote location. For example, the use of solar panels offers a limited amount of electrical power. Solar technology has a relative low power output, slow charging speeds, and is dependency of weather conditions.

Therefore, there is a fundamental need in the electric motorcycle industry for a solution to efficiently and effectively provide electricity to power electric motorcycles in recreational environments.

### SUMMARY

Disclosed herein is a novel electric motorcycle charging stand and methods of using such a novel electric motorcycle charging stand for charging an electric motorcycle. For most recreational and racing motorcycles, it is common to have a detached stand used for parking the motorcycle when not in use because traditional kickstand supports is either not allowed for racing purposes or generally ineffective because of the lack of hard and level surfaces to support the kickstand. Thus, it is very common for recreational and racing motorcycles to be park on a detached stand. Such detached stands present an opportunity to include functionality for storing energy and incorporate electronical components in the detached stand to charge electric motorcycles when not in use. In one embodiment a detached motorcycle stand can be arranged to stores electrical energy (for example, via an electrical energy storage element) and enables charging of an electric motorcycle (for example, via a charging enablement element). Thus, energy can be stored when there is convenient access to the electrical power grid and the electric motorcycle can then be charged in environments and locations that do not have ready access to the electrical grid.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates an embodiment of a charging stand for electric motorcycles; and

FIG. 2 schematically illustrates another embodiment of a charging stand for electric motorcycles.

### DETAILED DESCRIPTION

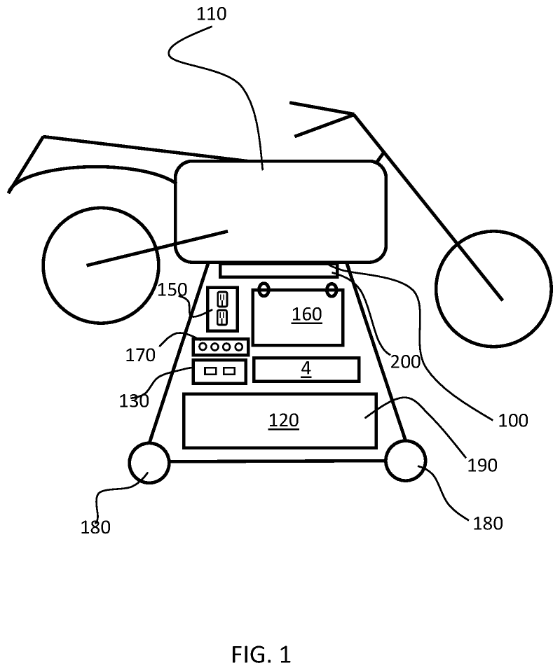

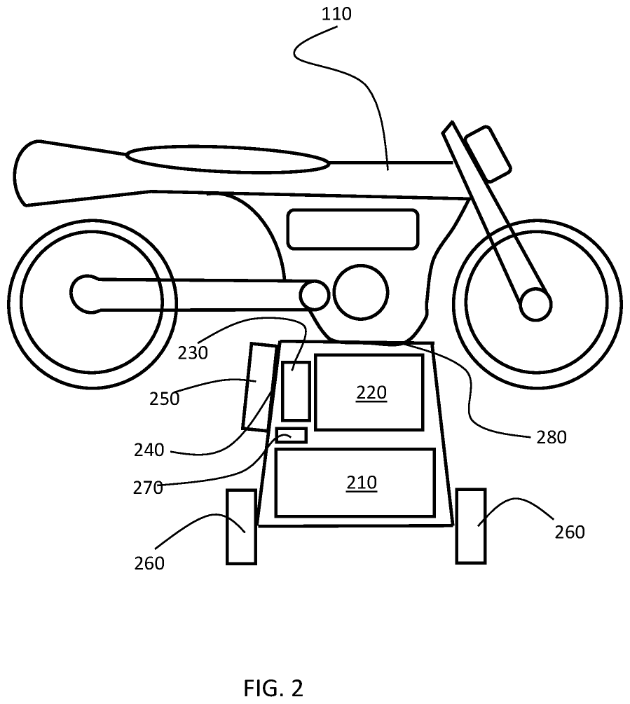

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of charging stands for electric motorcycles are hereinafter disclosed and described in detail with reference made to FIGS. 1-2.

In one embodiment, a motorcycle stand includes a holding support, energy storage functionality, electricity transformation functionality, and battery charging functionality. Each of these elements, and the combination of one or more of these elements, can all be achieved in various ways.

The motorcycle holding support can be arranged in a number of ways. One embodiment includes a stand with a structure sufficient to accommodate placing the electric motorcycle on top of the stand such that the frame or engine of the motorcycle rests the stand, where one or both wheels of the motorcycle are elevated above the ground. In another embodiment, the stand can accommodate leaning the motorcycle against or attached to the stand from one side, where the two wheels of the motorcycle remain on the ground. Another approach, typical of on-road motorcycles, is to engage the motorcycle at locations close to the axles or through the frame and lifting the motorcycle upward. Such lifting of the motorcycle can be accomplished manually by a user through mechanical means. Alternatively, as electrical power can be present with the stand, the stand could further be automated to lift the motorcycle using an integrated lifting solution operated by the user.

The storage of electric energy can be achieved through various possibilities. One solution is the use of a battery to store electric energy. Such a battery can itself be rechargeable. The chemistry of batteries continues to advance with existing battery types including lead-acid, Ni-Cad, NiMh, Li-ion, and the like. An alternative means to store energy is to use compressed gas such as hydrogen and oxygen. Compressed gas can be arranged to create a chemical reaction to produce electricity. Other possibilities include compressed air or compressed hydraulic fluid as a means to store energy for electrical power generation.

With a means to store energy incorporated into the stand, electricity can be generated and such generated energy can be transferred to the battery of the electric motorcycle to charge the battery. In the embodiment where the energy storage medium is itself a rechargeable battery mounted on the stand, electricity from the battery mounted on the stand needs to be converted to usable voltages and current acceptable for a battery charging device. A suitable method is to use an inverter to take DC battery power and convert it to AC power compatible with chargers that are designed for using a wall outlet associated with the electrical grid. In other battery scenarios, a DC to AC inverter can be excluded and a DC to DC solution can be achieved. With this a DC to DC power supply or converter is used to provide electricity directly to the motorcycle battery. Control may be required to facilitate proper battery charging either directly in the DC to DC device or in a separate DC based battery charger.

If other energy storage means are used, appropriate electrical power generation technology may be used. For the hydrogen and oxygen sources, a fuel cell can be used to convert the chemical energy into electrical energy. The output of the fuel cell can then use the same technologies as the battery case. If a compressed or hydraulic energy storage is used, a mechanical to electrical energy conversion much take place using an electrical generator. The output of the generator can go to an inverter stage, DC stage, or even direct charging stage.

The battery charging solution may be customized to the type and style of electric motorcycle. As the market and technology for electric motorcycles matures, standards may emerge to enable a universal charging solution. This leads to a flexible solution where the battery charger may be integrated with the stand or may simply be enabled by a device-specific holder for the motorcycle specific battery charger. With the charger being separate, the unique opportunity arises to use the charger to as a means to store energy in the stand when in an environment that has access to the electric power grid or when the electric power grid is not available.

In one exemplary embodiment, schematically illustrated in FIG. 1, a charging stand includes a platform 100 to support a motorcycle 110, a battery energy storage device 120, a charge port 130 to charge the battery energy storage device, a DC-AC inverter 140, an outlet for AC power 150, and a mount for a battery charger 6. Additionally, the charging stand can include a control and indicator panel 170, wheels 180 to facilitate transport, an internal battery charger 190 (storage and/or vehicle charging), and/or a cooling fan 200 for the vehicle, battery, charger, and/or inverter.

In another exemplary embodiment, schematically illustrated in FIG. 2, a charging stand includes a battery energy storage unit 210, a DC-AC inverter 220, an outlet for AC power 230, a mount for motorcycle charger 240, a charger 250, wheels for transport 260, a charger port 270 for the battery energy storage unit, and a base 280 for the motorcycle 110.

It will be appreciated that while several of the embodiments described herein set forth a combination of individual electronic modules (for example only, off-the-shelf products), any of such modules may be optionally combined in to one or more integrated modules. For example, a charger may be integrated into a stand by housing it in the stand, or it optionally may be integrated with other internal electronics of an embodiment. In another example, a single electronic module comprises multiple individual electronic modules, including more than one of the following: charge port, inverter, outlet, charger, fan, battery, control panel.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A motorcycle stand comprising:
at least one electrical energy storage element, and
at least one charging enablement element.

2. The motorcycle stand of claim 1 further comprising a support structure.

3. The accessory of claim 2, wherein the support structure is adapted to receive at least a part of an electric motorcycle for the purpose of facilitating electrical connection to a battery of the motorcycle.

4. The accessory of claim 2 wherein the electrical energy storage element is a battery.

5. The accessory of claim 2 wherein the charging enablement element includes a DC to DC power transmission means.

6. The accessory of claim 2 wherein the charging enablement element includes a DC to AC inverter.

7. An accessory for an electric motorcycle, comprising:
a motorcycle holding support;
energy storage means;
electricity generation means; and
battery charging means.

8. A device for providing energy to a motorcycle, comprising:
a platform for the motorcycle;
battery energy storage;
a charge port for the battery energy storage;
a DC-AC inverter;
an outlet for AC power; and
a mount for a battery charger.

9. The device of claim 8 further comprising a battery charger.

10. The device of claim 8, further comprising:
a control and indictor panel,
wheels for transport,
an internal battery charger, and
a cooling fan.
